(19) United States
(12) Patent Application Publication
(10) Pub. No.: US 2025/0299186 A1
(43) Pub. Date: Sep. 25, 2025

(54) METHOD FOR DIGITAL CURRENCY INTRA-CHAIN AND CROSS-CHAIN OFF-CHAIN PAYMENTS BASED ON TRUSTED HARDWARE

(71) Applicant: ZHEJIANG UNIVERSITY, Hangzhou (CN)

(72) Inventors: Jian LIU, Hangzhou (CN); Di WU, Hangzhou (CN); Kui REN, Hangzhou (CN); Wu WEN, Hangzhou (CN)

(21) Appl. No.: 19/053,430

(22) Filed: Feb. 14, 2025

(30) Foreign Application Priority Data
Mar. 19, 2024 (CN) 202410312614.7

(51) Int. Cl. G06Q 20/38; H04L 9/14

(52) U.S. Cl. CPC G06Q 20/3829; H04L 9/14; G06Q 2220/00

(57) ABSTRACT

A method for digital currency intra-chain and cross-chain off-chain payments based on trusted hardware. By creating and transferring a public-private key pair saved and managed by a trusted hardware system to replace the on-chain payment, the trusted hardware ensures the security of the transaction, avoids complicated on-chain transaction steps, reduces the long on-chain transaction time and high on-chain transaction cost, and neglects the differences among blockchain systems to support cross-chain transactions, thus greatly improving the intra-chain and cross-chain off-chain payment efficiency in digital currency and greatly reducing the payment cost in digital currency. In addition, on the basis of the above payment method, the corresponding rescue object generation process of different digital currency types and the process of using the rescue object to retrieve digital currency are further proposed, which avoids the problem of asset loss caused by the damage or loss of trusted hardware.

### CROSS-REFERENCE TO RELATED APPLICATIONS

The present application claims priority to Chinese Patent Application No. 202410312614.7, filed on Mar. 19, 2024, the content of which is incorporated herein by reference in its entirety.

### TECHNICAL FIELD

The present disclosure belongs to the field of information technology, and in particular, to a method for digital currency intra-chain and cross-chain off-chain payments based on trusted hardware.

### BACKGROUND

With the continuous development of blockchain and digital currency, the transaction volume in digital currencies is gradually increasing, demanding higher levels of security and efficiency of transactions. The traditional blockchain transaction method mainly relies on the open account books among network participants, which largely ensures the transparency and non-tampering of the transaction but also presents issues such as low transaction efficiency, high cost and insufficient privacy protection.

To address these challenges, various off-chain trading solutions have been proposed. However, the performance of solutions such as lightning network still exhibits weak performance, and there are some security and reliability issues.

Moreover, with the emergence of different kinds of cryptocurrencies, such as Bitcoin and Ethereum, and digital currency, the central bank, the demand for cross-chain transactions is more and more urgent, but most off-chain trading systems do not support cross-chain transactions.

Therefore, it is necessary to develop a safe, efficient and cross-chain trading system and method. In this respect, trusted hardware such as hardware security module (HSM) and trusted execution environment (TEE) provide a potential solution.

### SUMMARY

The object of the present disclosure is to solve the above problems, and to provide a method for digital currency intra-chain and cross-chain off-chain payments based on trusted hardware to realize safe and efficient digital currency intra-chain or cross-chain payment.

According to a first aspect of the embodiment of the present disclosure, there is provided a method for digital currency intra-chain and cross-chain off-chain payments based on trusted hardware, including the following steps:
(1) Randomly generating, by a trusted hardware system of a payer, a public-private key pair (pk_{A}^{TEE},sk_{A}^{TEE}), generating, by a private key sk_{A}^{TEE}, a signature σ_{A} for a public key pk_{A}^{TEE}, and returning the public key pk_{A}^{TEE} and the signature σ_{A} to a software system of the payer.
(2) Calculating, by the software system of the payer, a digital currency address addr through the public key pk_{A}^{TEE}, and depositing, by a blockchain, a digital currency to the digital currency address addr.
(3) Sending, by the software system of the payer, the digital currency address addr to a software system of a payee, and verifying, by the software system of the payee, whether there is a corresponding digital currency at addr; and after verifying, transmitting, by the software system of the payee, an encryption public key pk_{B} to the software system of the payer.
(4) Sending, by the software system of the payer, the public keys pk_{A}^{TEE} and the encryption public key pk_{B} to the trusted hardware system of the payer, requesting the trusted hardware system of the payer to transfer (pk_{A}^{TEE},sk_{A}^{TEE}), performing, by the trusted hardware system of the payer, asymmetric encryption on sk_{A}^{TEE} by using pk_{B} to generate a ciphertext C_{A}, deleting (pk_{A}^{TEE},sk_{A}^{TEE}) from a confidential storage space of the trusted hardware system of the payer, signing the ciphertext C_{A} by a trusted hardware signature private key [symbol] and generating a signature σ′_{A}, and returning the ciphertext C_{A} and the signature σ′_{A} to the software system of the payer.
(5) Sending, by the software system of the payer, the public key pk_{A}^{TEE}, the signature σ_{A}, the ciphertext C_{A} and the signature σ′_{A} to the software system of the payee.
(6) When the public key pk_{B} being a trusted hardware encryption public key [symbol] of the trusted hardware of the payee, sending, by the software system of the payee, the public key pk_{A}^{TEE}, the signature σ_{A}, the ciphertext C_{A}, the signature σ′_{A} and a trusted hardware signature public key [symbol] of the payer to the trusted hardware of the payee, and verifying, by the trusted hardware system of the payee, whether σ_{A} is a signature for pk_{A}^{TEE} by the payer using [symbol] and whether σ′_{A} is a signature for the ciphertext C_{A} by the payer using [symbol] by using the trusted hardware signature public key [symbol] , and when said verifying being passed, decrypting, by [symbol] , the ciphertext C_{A} to obtain sk_{A}^{TEE}, and saving (pk_{A}^{TEE},sk_{A}^{TEE}).
(7) When the public key pk_{B} not being a trusted hardware encryption public key [symbol] of the trusted hardware of the payee, verifying, by the software system of the payee, whether σ_{A} is a signature for pk_{A}^{TEE} by the payer using [symbol] , and whether σ′_{A} is a signature for the ciphertext C_{A} by the payer using [symbol] by using [symbol] , when said verifying being passed, decrypting, by a corresponding private key sk_{B} of the public key pk_{B}, the ciphertext C_{A} to obtain sk_{A}^{TEE}, generating, by the software system of the payee, a transaction that is transferred from the corresponding digital currency address addr to a personal digital currency address of the payee by using (pk_{A}^{TEE},sk_{A}^{TEE}), and submitting the transaction to the blockchain for withdrawal for the digital currency.

Further, storing, by the trusted hardware system of the payer or the payee, the public-private key pair (pk_{A}^{TEE},sk_{A}^{TEE}) in the confidential storage space comprises: directly storing the public-private key pair in the trusted hardware or encrypting the public-private key pair by the trusted hardware with a key that does not leak and storing the public-private key pair in a specific area, wherein data stored in the confidential storage space are not capable of being read by any device, system, software or user except the trusted hardware system in any way.

Further, before verifying by the payee in the step (3), when there has been no prior transaction between the payee and the payer, calling, by the software system of the payee, trusted hardware attestation technology to verify whether the trusted hardware system of the payer is running on a reliable trusted hardware, and when verifying being passed, obtaining the public key of the trusted hardware signature [symbol] of the payer and storing the public key of the trusted hardware signature [symbol] of the payer in the software system of the payee.

Further, after the step (6) when the payee needs to withdraw a digital currency, following steps are performed:

Inputting, by the software system of the payee, a public key pk′_{B} to the trusted hardware system of the payee, requesting the trusted hardware system of the payee to transfer (pk_{A}^{TEE}, sk_{A}^{TEE}), performing, by the trusted hardware system of the payee, asymmetric encryption on sk_{A}^{TEE} by using pk′_{B}, to generate a ciphertext C′_{A}, deleting (pk_{A}^{TEE},sk_{A}^{TEE}) from the confidential storage space, signing the ciphertext C′_{A} by a trusted hardware signature private key [symbol] to generate a signature σ″_{A}, and sending the ciphertext C′_{A} and the signature σ″_{A} to the software system of the payee.

Verifying, by the software system of the payee, whether σ′_{A} is a signature for pk_{A}^{TEE} by the payee using [symbol] and whether σ″_{A} is a signature for the ciphertext C′_{A} by the trusted hardware system of the payee using [symbol] by using the [symbol] , when said verifying being passed, decrypting, by a corresponding private key sk′_{B} of the public key pk′_{B}, the ciphertext C′_{A} to obtain sk_{A}^{TEE}, generating, by the software system of the payee, a transaction of transferring from addr to the personal digital currency address of the payee by using (pk_{A}^{TEE},sk_{A}^{TEE}), and submitting the transaction to the blockchain for withdrawal for the digital currency.

According to a second aspect of the embodiment of the present disclosure, there is provided a method for digital currency intra-chain and cross-chain off-chain rescuable payments based on trusted hardware, including the following steps:
(1) Randomly generating, by a trusted hardware system of a payer, a public-private key pair (pk_{A}^{TEE},sk_{A}^{TEE}), generating, by a private key sk_{A}^{TEE}, a signature σ_{A} for a public key pk_{A}^{TEE}, and returning the public key pk_{A}^{TEE} and the signature σ_{A} to a software system of the payer.
(2) Calculating, by the software system of the payer, a digital currency address addr through the public key pk_{A}^{TEE}, depositing, by a blockchain, a digital currency to the digital currency address; sending, by the software system of the payer, the public key pk_{A}^{TEE}, a digital currency type, a payer rescue address addr_{A} preset by the payer and an earliest rescue time t expected by the payer to the trusted hardware system of the payer, requesting the trusted hardware system of the payer to generate a rescue object for (pk_{A}^{TEE},sk_{A}^{TEE}), signing the earliest rescue time t expected by the payer using [symbol] to generate a signature σₜ, and sending the rescue object, the earliest rescue time t expected by the payer and the signature σₜ to the software system of the payer.
(3) Sending, by the software system of the payer, the digital currency address addr and the earliest rescue time t expected by the payer to a software system of a payee, and verifying, by the software system of the payee, whether there is a corresponding digital currency at addr and confirming whether to accept the earliest rescue time t expected by the payer; and when the payee does not accept the earliest rescue time t expected by the payer, terminating the transaction, otherwise, after verifying, transmitting, by the software system of the payee, an encryption public key pk_{B} to the software system of the payer.
(4) Sending, by the software system of the payer, the public keys pk_{A}^{TEE} and the encryption public key pk_{B} to the trusted hardware system of the payer, requesting the trusted hardware system of the payer to transfer (pk_{A}^{TEE},sk_{A}^{TEE}), performing, by the trusted hardware system of the payer, asymmetric encryption on sk_{A}^{TEE} by using pk_{B} to generate a ciphertext C_{A}, deleting (pk_{A}^{TEE} sk_{A}^{TEE}) from a confidential storage space of the trusted hardware system of the payer, signing the ciphertext C_{A} by a trusted hardware signature private key [symbol] to generate a signature σ′_{A}, and returning the ciphertext C_{A} and the signature σ′_{A} to the software system of the payer.
(5) Sending, by the software system of the payer, the public key pk_{A}^{TEE}, the signature σ_{A}, the ciphertext C_{A}, the signature σ′_{A}, the earliest rescue time t expected by the payer and the signature σₜ to the software system of the payee.
(6) When the public key pk_{B} being a trusted hardware encryption public key [symbol] of the trusted hardware of the payee, sending, by the software system of the payee, the public key pk_{A}^{TEE}, the signature σ_{A}, the ciphertext C_{A}, the signature σ_{A}, the rescue time t, the signature σₜ and a trusted hardware signature public key [symbol] of the payer to the trusted hardware of the payee, verifying, by the trusted hardware system of the payee, whether σ_{A} is a signature for pk_{A}^{TEE} by the payer using [symbol] , whether σ′_{A} is a signature for C_{A} by the payer using [symbol] and whether σₜ is a signature for t by the payer using [symbol] by using [symbol] , when said verifying being passed, determining whether the rescue time t is in an acceptable range, and when the rescue time t is in the acceptable range, performing asymmetrically decryption on C_{A} by using [symbol] to obtain sk_{A}^{TEE} and storing (pk_{A}^{TEE},sk_{A}^{TEE}); and sending, by the software system of the payee, the public key pk_{B}^{TEE}, a digital currency type, a payee rescue address addr_{B} preset by the payee and an earliest rescue time t′ expected by the payee to the trusted hardware system of the payee, and requesting the trusted hardware system of the payee to generate a rescue object for (pk_{A}^{TEE},sk_{A}^{TEE}).
(7) When the public key pk_{B} not being a trusted hardware encryption public key [symbol] of the trusted hardware of the payee, verifying, by the software system of the payee, whether σ_{A} is a signature for pk_{A}^{TEE} by the payer using [symbol] and whether σ′_{A} is a signature for the ciphertext C_{A} by the payer using [symbol] by using [symbol] , when said verifying being passed, decrypting, by a corresponding private key sk_{B} of the public key pk_{B}, the ciphertext C_{A} to obtain sk_{A}^{TEE}, generating, by the software system of the payee, a transaction that is transferred from the corresponding digital currency address addr to a personal digital currency address of the payee by using (pk_{A}^{TEE}, sk_{A}^{TEE}), and submitting the transaction to the blockchain for withdrawal for the digital currency.

Further, for a digital currency that supports deferred transactions, generating, by the trusted hardware system of the payer, a transaction tx_{A} signed with sk_{A}^{TEE}, with a nTimeLock field being the earliest rescue time t expected by the payer and a SIGHASH flag bit being SIGHASH_ALL, and transferred from addr to addr_{A}, and returning the transaction tx_{A} as the rescue object to the software system of the payer.

For a digital currency that does not support deferred transactions but supports smart contracts, generating, by the trusted hardware system of the payer, a deferred transfer function that calls smart contracts that support deferred transactions, so as to achieve a called transactions call_{A} of transferring from addr to addr_{A} with an earliest executable time being t, and returning the transaction call_{A} as the rescue object to the software system of the payer.

For a digital currency that does not support deferred transactions or smart contracts, obtaining, by the trusted hardware system of the payer, a current time t_{now} through a trusted clock or trusted timing point, generating a time lock puzzle puzzle_{A} with a secret being sk_{A}^{TEE}, a computing performance being a current computing performance constant and an unlocking duration being t−t_{now} through a generation algorithm in a time lock puzzle algorithm, and returning the time lock puzzle puzzle_{A} to the software system of the payer as the rescue object, wherein the time lock puzzle algorithm comprises but is not limited to RSW time lock puzzle algorithms.

Further, a process for the payer to retrieve the digital currency deposited at addr to the rescue address addr_{A} includes:

For the digital currency that supports the deferred transactions, after submitting the earliest rescue time t expected by the payer, submitting, by the payer, tx_{A} to a blockchain system through the software system of the payer or any blockchain client supporting the digital currency, and retrieving the digital currency deposited at addr to the rescue address addr_{A} after confirmation by the blockchain system.

For the digital currency that does not support the deferred transactions but supports the smart contracts, after submitting the earliest rescue time t expected by the payer, submitting, by the payer, call_{A} to the blockchain system through the software system of the payer or any blockchain client that supports the digital currency, and retrieving the digital currency deposited at addr to the rescue address addr_{A} after confirmation by the blockchain system.

For the digital currency that does not support the deferred transactions or the smart contracts, immediately starting, by the payer, to execute a decryption algorithm of the corresponding time lock puzzle algorithm after obtaining puzzle_{A}, solving, by the payer, puzzle_{A} to obtain sk_{A}^{TEE} before and after the earliest rescue time t expected by the payer, generating a transaction of transferring from addr to the personal digital currency address of the payer with the software system, and submitting the transaction to the blockchain to retrieve the digital currency.

Further, after step (6), if the payee needs to withdraw a digital currency, then:

Sending, by the software system of the payee, a public key pk′_{B} to the trusted hardware system of the payee, requesting the trusted hardware system of the payee to transfer (pk_{A}^{TEE},sk_{A}^{TEE}), performing, by the trusted hardware of the payee asymmetric encryption on sk_{A}^{TEE} by using pk′_{B}, to generate a ciphertext C′_{A}, deleting (pk_{A}^{TEE},sk_{A}^{TEE}) from the confidential storage space, signing the ciphertext C′_{A} by a trusted hardware signature private key [symbol] , to generate a signature σ″_{A}, and returning the ciphertext C′_{A} and the signature σ″_{A} to the software system of the payee.

Verifying, by the software system of the payee, whether σ′_{A} is a signature for pk_{A}^{TEE} by the payee using [symbol] , usinp [symbol] to verily whether σ″_{A} is a signature for C′_{A} by the trusted hardware system of the payee using [symbol] by using [symbol] , when said verifying being passed, decrypting, by the corresponding private key sk′_{B} of the public key pk′_{B}, the ciphertext C′_{A} to obtain sk_{A}^{TEE}, generating, by the payee, a transaction of transferring from addr to the personal digital currency address of the payee by using (pk_{A}^{TEE},sk_{A}^{TEE}) through the software system of the payee, and submitting the transaction to the blockchain for withdrawal for the digital currency.

According to a third aspect of the embodiment of the present disclosure, there is provided an electronic device, including: one or more processors; and a memory for storing one or more programs.

When the one or more programs are executed by the one or more processors, the one or more processors are caused to implement the method according to the first aspect.

According to a fourth aspect of the embodiment of the present disclosure, there is provided a computer-readable storage medium having computer instructions stored thereon. The instructions, when executed by a processor, implement the steps of the method according to the first aspect.

The technical solutions provided by the embodiment of the present disclosure can include the following beneficial effects:

The present disclosure proposes a method for digital currency intra-chain and cross-chain off-chain payments based on trusted hardware. The method replaces the on-chain payment with a public-private key pair saved and managed by a trusted hardware system, and the security of the transaction is ensured by the trusted hardware, thereby avoiding complicated on-chain transaction steps, reducing lengthy on-chain transaction times, eliminating high on-chain transaction costs, ignoring differences between blockchain systems to support cross-chain transactions, and thus greatly improving the digital currency intra-chain and cross-chain payment efficiency and significantly reducing the digital currency payments. Compared with the related art, embodiments of the present disclosure achieve cross-chain payments for the digital currency, greatly improving the timeliness and convenience of the digital currency intra-chain and cross-chain transaction payment flow, ensuring its security, and reducing its payment cost.

The present disclosure further provides a method for digital currency intra-chain and cross-chain off-chain rescuable payment based on trusted hardware. On the basis of the above payment method, the corresponding rescue object generation process and the process of using rescue objects to retrieve digital currencies are proposed according to different digital currency types, thereby avoiding the problem of asset loss caused by damage or loss of trusted hardware.

It is to be understood that both the foregoing general description and the following detailed description are exemplary and explanatory only and are not restrictive of the present disclosure.

### BRIEF DESCRIPTION OF DRAWINGS

The accompanying drawings, which are incorporated in and constitute a part of this specification, illustrate embodiments consistent with the present disclosure and together with the description, serve to explain the principles of the present disclosure.

FIG. 1 is a schematic diagram of a payer and a payee in a method for digital currency intra-chain and cross-chain off-chain payments based on trusted hardware according to an exemplary embodiment;

FIG. 2 is a schematic diagram of a method for digital currency intra-chain and cross-chain off-chain payments based on trusted hardware according to an exemplary embodiment;

FIG. 3 is a schematic diagram showing the withdrawal after payment through the method for digital currency intra-chain and cross-chain off-chain payments based on trusted hardware according to an exemplary embodiment;

FIG. 4 is a flow chart of a method for digital currency intra-chain and cross-chain off-chain payments based on trusted hardware according to an exemplary embodiment; and

FIG. 5 is a schematic diagram of an electronic device according to an exemplary embodiment.

### DESCRIPTION OF EMBODIMENTS

Reference will now be made in detail to exemplary embodiments, examples of which are illustrated in the accompanying drawings. When the following description refers to the drawings, unless otherwise indicated, the same numbers in different drawings indicate the same or similar elements. The embodiments described in the following exemplary embodiments do not represent all embodiments consistent with the present disclosure.

The terminology used in the present disclosure is for the purpose of describing specific embodiments only and is not intended to limit the present disclosure. The singular forms “a”, “said” and “the” used in the present disclosure and the appended claims are further intended to include the plural forms, unless the context clearly indicates other meaning. It should further be understood that the term “and/or” as used herein refers to and includes any or all possible combinations of one or more associated listed items.

It should be understood that although the terms first, second, third, etc. may be used in the present disclosure to describe various information, this information should not be limited to these terms. These terms are only used to distinguish the same type of information from each other. For example, without departing from the scope of the present disclosure, the first information can further be called the second information, and similarly, the second information can further be called the first information. Depending on the context, the word “if” as used herein can be interpreted as “when” or “in case of” or “in response to a determination”.

### Example 1

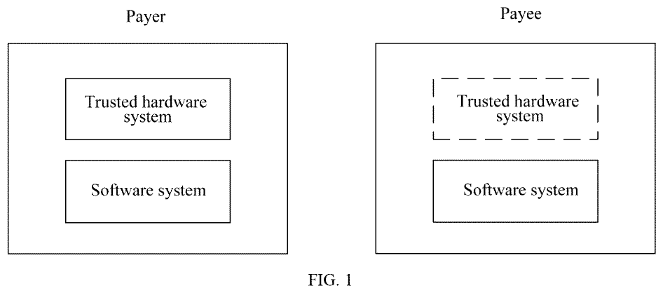

The method for digital currency intra-chain and cross-chain off-chain payments based on trusted hardware in the embodiment of the present disclosure mainly involves two participants, namely a payer and a payee. The payer and the payee can be institutions (such as commercial banks) or ordinary users (such as commodity buyers and sellers). The digital currency transaction can take place under the scenes of off-chain commodity transaction, online electronic payment and the like. As shown in FIG. 1, the payer has a software system running on a computer device or a mobile device and a trusted hardware system running on trusted hardware, and the payee has at least the software system. Understandably, in practice, the same user can appear as the payer and the payee in different digital currency transactions.

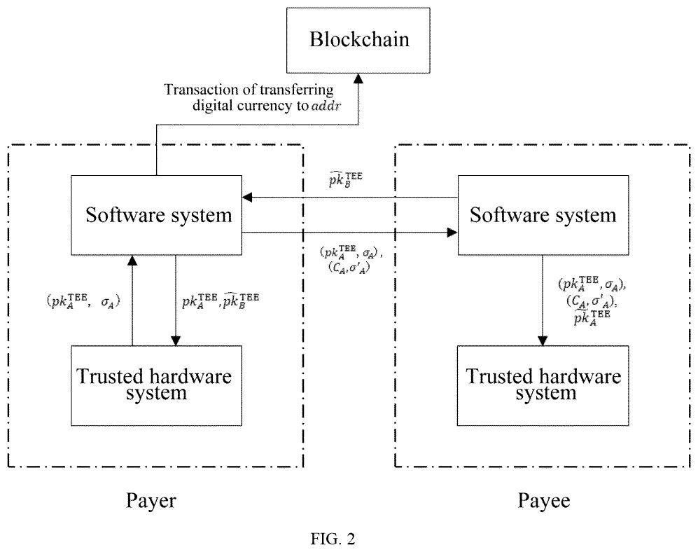

FIG. 2 is a schematic diagram of a method for digital currency intra-chain and cross-chain off-chain payments based on trusted hardware according to an exemplary embodiment. As shown in FIG. 2, the method mainly involves the following steps:
(1) A trusted hardware system of a payer randomly generates a public-private key pair (pk_{A}^{TEE},sk_{A}^{TEE}), uses the private key sk_{A}^{TEE} to generate a signature σ_{A} for the public key, and returns the public key pk_{A}^{TEE} and the signature σ_{A} to a software system of the payer; this step generates a public-private key pair stored and controlled by trusted hardware through the trusted hardware system, which makes it possible to create a secure blockchain account controlled and managed by trusted hardware in the following steps. In this step, the trusted hardware system of the payer saves the public-private key pair (pk_{A}^{TEE},sk_{A}^{TEE}) as confidential content in a confidential storage space, including directly storing it in the trusted hardware or encrypting it by the trusted hardware with a key that will not leak and storing it in a specific area, and the private key cannot be read by any device, system, software or user except the trusted hardware system in any way.

It should be noted that each trusted hardware system automatically generates two public-private key pairs randomly after initialization: 1) one for encryption ( [symbol] , [symbol] ), where the former is a public key and the latter is a private key; and 2) one for signing ( [symbol] , [symbol] ). The former is a public key and the latter is a private key. When a payee and a payer lave a transaction for the first time, they should use the attestation technology attached to their trusted hardware to verify that the payer is using a reliable trusted hardware, and obtain the trusted hardware signature public key [symbol] the above payer and save it in the software system of the payee.

The trusted hardware can be implemented by a hardware security module (HSM) or a trusted execution environment (TEE), and its specific implementation includes but is not limited to Intel SGX, ARM TrustZone and other popular TEE or HSM solutions.

It should be noted that the trusted hardware provides a secret storage function, which can save, read, update and delete confidential contents into a confidential storage space. Its implementation methods include but are not limited to storing confidential contents in a storage chip in the trusted hardware, encrypting the confidential contents with an encryption key built in the trusted hardware and storing the encrypted ciphertext in a storage space outside the trusted hardware. After being written, the confidential content cannot be read, modified or deleted by any device, user, system or software in any way, and after being deleted, it cannot be recovered and read by any device, user, system or software in any way.

The process of randomly generating a public-private key pair refers to randomly generating a public-private key pair based on digital signature solutions of asymmetric encryption, including but not limited to RSA, ECDSA, Schnorr and SM-2.

The process of generating a signature refers to the process of generating a digital signature for a signature content by using a signature algorithm based on asymmetric encryption corresponding to a private key after inputting the private key and the signature content.
(2) The software system of the payer calculates the digital currency address addr through the public key pk_{A}^{TEE}, and deposits a digital currency into the digital currency address through a blockchain. The blockchain is a blockchain system corresponding to the digital currency; the digital currency address is calculated by the software system of the payer according to the public key pk_{A}^{TEE} according to the method specified by the digital currency; this step creates a blockchain account managed by the trusted hardware system by transferring money to the digital currency address corresponding to the public key in the public-private key pair stored and managed by the trusted hardware system, and because the account is managed by the trusted system, users cannot achieve double spend attacks or other malicious behaviors no matter what operations they do, thus ensuring the transaction security.

It should be noted that it is common knowledge in this field that there is a blockchain system for the digital currency, and the digital currency address can be calculated according to the public key according to the method specified by the digital currency, which will not be repeated here.
(3) The software system of the payer sends the digital currency address addr to the software system of the payee, and the software system of the payee verifies (through the blockchain browser or any other method) whether there is a corresponding digital currency at the digital currency address addr. After verification, the payee uses its software system to give an encryption public key pk_{B} to the software system of the payer. The public key can be the public key [symbol] of the trusted hardware of the payee, or any public key. The benefits of this step are as follows: 1) by observing whether the blockchain account with the address of addr and managed by the trusted hardware system on the blockchain meets the requirements of the payee, the payee can confirm that the transaction can meet its requirements, thus ensuring the security of the transaction; 2) by allowing the provision of any public key, the payee who owns both the software system and the trusted hardware system can participate in the transaction with the payee who only owns the software system, which greatly expands the user group who can be used as the payee on the premise of ensuring security.

In this step, whether there is a digital currency at the address addr/account on the blockchain system is browsed through the built-in blockchain browser or other blockchain browsers or any method.

In this step, if there has been no prior transaction between the payee and the payer, the payee should call the trusted hardware attestation technology through its software system to verify whether the trusted hardware system of the payer is running on the reliable trusted hardware. If the verification is passed, a trusted hardware signature public key of the payer [symbol] is obtained and stored in the software system of the payee.
(4) The software system of the payer sends pk_{A}^{TEE} and the public key pk_{B} provided by the payee to the trusted hardware system of the payer, requesting it to transfer (pk_{A}^{TEE},sk_{A}^{TEE}), and the trusted hardware system of the payer uses pk_{B} to perform asymmetric encryption on sk_{A}^{TEE} to generate a ciphertext C_{A}, deletes (pk_{A}^{TEE},sk_{A}^{TEE}) from the confidential storage space, signs C_{A} with its trusted hardware signature private key [symbol] to generate a signature σ′_{A} and returns C_{A} and σ′_{A} to the software system of the payer. When the trusted hardware system of the payer deletes the private key sk_{A}^{TEE} in the confidential storage space, no system, equipment, software or user can obtain the private key again. This step completes the transfer of digital currency assets by transferring (pk_{A}^{TEE},sk_{A}^{TEE}), which avoids complex, time-consuming and expensive on-line transactions and realizes fast, free and safe off-line transactions; Moreover, because the transfer of (pk_{A}^{TEE},sk_{A}^{TEE}) is decoupled from the specific blockchain system, payment across different blockchains is naturally realized. In this step, the asymmetric encryption includes directly encrypting the input public key and the original text with an encryption algorithm including but not limited to RSA, SM-2 and other asymmetric encryption solutions to obtain the ciphertext, and it further includes encrypting the input public key and the original text with the encryption algorithm of a hybrid encryption solution, that is, a one-time key is randomly generated, the input one-time key and the original text use symmetric encryption algorithms including but not limited to AES, DES, SM-1 to generate a symmetric encrypted ciphertext, and the input public key and the one-time key use asymmetric encryption algorithms including but not limited to RSA and SM-2 to generate an asymmetric encrypted ciphertext.

The payer inputs the public key provided by the payee to the software system of the payer, and the software system of the payer transmits the public key and the transfer request to the trusted hardware of the payer. The trusted hardware of the payer uses this public key to asymmetrically encrypt the public-private key pair in step 1 to generate a ciphertext, deletes the public-private key pair in the trusted storage space, signs the ciphertext with the private key of the trusted hardware, and returns the above ciphertext and signature to the software system of the payer.
(5) The software system of the payer sends the public key pk_{A}^{TEE}, the signature σ_{A}, the ciphertext C_{A} and a signature σ′_{A} to the software system of the payee.
(6) If the public key pk_{B} is the trusted hardware encryption public key [symbol] of the trusted hardware of the payee, the software system of the payee sends public key pk_{A}^{TEE}, the signature σ_{A}, the ciphertext C_{A}, the signature σ′_{A} and the trusted hardware signature public key [symbol] of the payer to the trusted hardware of the payee, and the trusted hardware system of the payee uses [symbol] to verify whether σ_{A} is a signature for pk_{A}^{TEE} by the payer using [symbol] and whether σ′_{A} is a signature for C_{A} by the payer using [symbol] , and if the verify is passed, uses [symbol] to perform asymmetric decryption on C_{A} to obtain sk_{A}^{TEE}, and stores (pk_{A}^{TEE},sk_{A}^{TEE}); the advantage of this step is that after completing this step, the payee can use (pk_{A}^{TEE},sk_{A}^{TEE}) for off-chain transactions again in other scenarios, and realize the rapid transfer of digital currency assets without on-chain cost.

In this step, the process of verifying the signature refers to the process of inputting the public key, signature and signature content, and then verifying whether the input signature is generated by signing the signature content with the private key corresponding to the input public key by using the verification algorithm of the digital signature solution based on asymmetric encryption.

In this step, the asymmetric decryption not only includes the input private key and the original text using asymmetric encryption solutions including but not limited to RSA, SM-2 to decrypts the ciphertext to obtain the original text, further includes the input private key, symmetric encryption ciphertext and asymmetric encryption ciphertext using the decryption algorithm of hybrid encryption solutions for decryption, that is, the input private key and asymmetric encryption ciphertext use the decryption algorithm including but not limited to AES, DES, SM-1 and other symmetric encryption solutions to obtain the one-time key, and the input one-time key and symmetric encryption ciphertext use the decryption algorithm including but not limited to RSA, SM-2 and other asymmetric encryption solutions to obtain the original text. Thereafter, optionally, when the payee acts as a new payer subsequently, sk_{A}^{TEE} can be paid to other users again by the above steps (1) to (5) of its software system.
(7) Otherwise, the software system of the payee uses [symbol] to verify whether σ_{A} is a signature for pk_{A}^{TEE} by the payer using [symbol] and whether σ′_{A} is a signature for C_{A} by the payer using [symbol] . If the verify is passed, C_{A} is decrypted with the corresponding private key sk_{B} of the public key pk_{B} to obtain sk_{A}^{TEE}. The software system of the payee uses (pk_{A}^{TEE},sk_{A}^{TEE}) to generate a transaction of transferring from the corresponding digital currency address addr to the personal digital currency address of the payee and submit the transaction to the blockchain for withdrawal for the digital currency. This step enables the payee to safely complete the off-chain transaction without a trusted hardware system.

Thereafter, the payee can use (pk_{A}^{TEE},sk_{A}^{TEE}) to generate a transaction of transferring from the corresponding digital currency address addr to the personal digital currency address of the payee through its software system, and submit the transaction to the blockchain for withdrawal for the digital currency.

After the execution of the above steps, the payment part of the digital currency off-chain payment method the based on trusted hardware is completed.

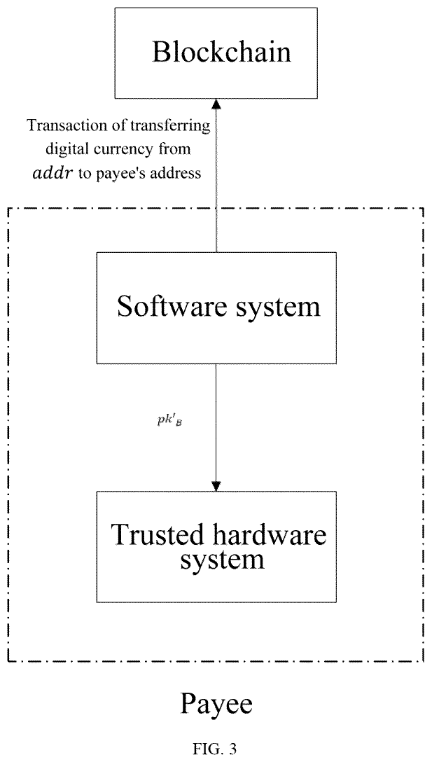

As shown in FIG. 3, if the payee needs to withdraw a digital currency after performing step 6, the following will be executed.
(8) The payee inputs a public key pk′_{B} to its trusted hardware system through the software system of the payee to request for transferring of (pk_{A}^{TEE},sk_{A}^{TEE}), and its trusted hardware uses pk′_{B} to perform asymmetric encryption on sk_{A}^{TEE} to generate a ciphertext C′_{A}, and deletes (pk_{A}^{TEE},sk_{A}^{TEE}) from the confidential storage space, and uses its trusted hardware signature private key [symbol] to sign C′_{A} and generate a signature σ″_{A}, and C′_{A} and σ″_{A} are returned to the software system of the payee. When the trusted hardware system of the payee deletes the private key sk_{A}^{TEE} in the confidential storage space, no user, software, system or equipment can obtain the private key again. The advantage of this step is that sk_{A}^{TEE} is not stored in the trusted hardware of the payee, and it is ensured that sk_{A}^{TEE} cannot be double spent.
(9) The software system of the payee first uses [symbol] to verify whether σ′_{A} is a signature for pk_{A}^{TEE} by the payee using [symbol] , and then uses [symbol] to verify whether σ″_{A} is a signature for C′_{A} by the trusted hardware system of the payee using [symbol] ; if the verify is passed, a corresponding private key sk′_{B} of the public key pk′_{B} provided in step 7 is used to decrypt the ciphertext C′_{A} to obtain sk_{A}^{TEE}; then the software system of the payee uses (pk_{A}^{TEE},sk_{A}^{TEE}) to generate a transaction of transferring from addr to the personal digital currency address of the payee and submit the transaction to the blockchain for withdrawal for the digital currency.

In the example of the present disclosure, by adopting the method for digital currency intra-chain and cross-chain off-chain payments based on trusted hardware, a system for digital currency intra-chain and cross-chain off-chain payments based on trusted hardware can be constructed, so that the function of digital currency intra-chain and cross-chain off-chain payment can be realized. According to the present disclosure, the public-private key pair saved and managed by the trusted hardware system is created and transferred to replace the on-chain payment, so that the trusted hardware ensures the security of the transaction, avoids complicated on-chain transaction steps, reduces the long on-chain transaction time and the high on-chain transaction cost, and neglects the differences among blockchain systems to support cross-chain transactions, thereby greatly improving the digital currency intra-chain and cross-chain payment efficiency and greatly reducing the digital currency payment cost.

### Example 2

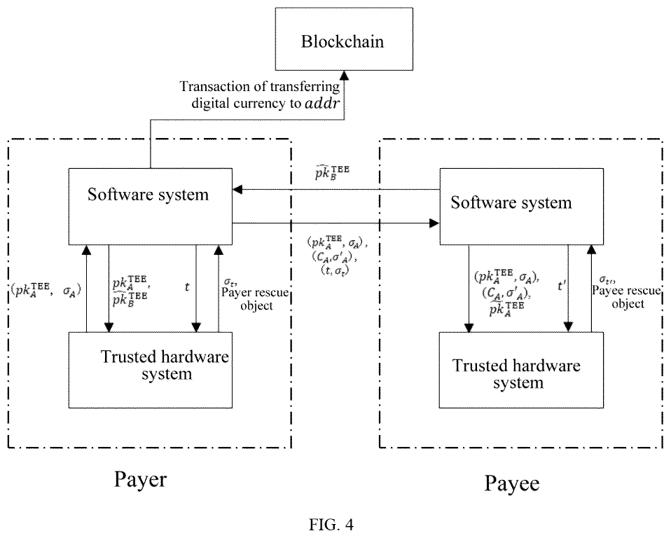

The present disclosure further provides a digital currency intra-chain and cross-chain off-chain rescuable payment method based on trusted hardware. On the basis of Example 1, the content that can be rescued when the trusted hardware crashes is added to avoid the problem of asset loss caused by the damage or loss of the trusted hardware. As shown in FIG. 4, the method mainly involves the following steps:
(1) The trusted hardware system of the payer randomly generates a public-private key pair (pk_{A}^{TEE},sk_{A}^{TEE}), uses the private key sk_{A}^{TEE} to generate a signature σ_{A} for the public key pk_{A}^{TEE}, and returns the public key pk_{A}^{TEE} and the signature σ_{A} to the software system of the payer.
(2) The software system of the payer calculates a digital currency address addr through the public key pk_{A}^{TEE}, and deposits a digital currency in the digital currency address through a blockchain; the software system of the payer sends the public key pk_{A}^{TEE}, a digital currency type, a payer rescue address addr_{A} preset by the payer and an earliest rescue time t expected by the payer to the trusted hardware system of the payer, requests the trusted hardware system of the payer to generate a rescue object for (pk_{A}^{TEE},sk_{A}^{TEE}), and signs the earliest rescue time t expected by the payer using [symbol] to generate a signature σₜ, and sends the rescue object, the earliest rescue time t expected by the payer and the signature σₜ to the software system of the payer. The blockchain is a blockchain system corresponding to the digital currency; the digital currency address is calculated by the software system of the payer according to the public key pk_{A}^{TEE} according to the method specified by digital currency.

After deposited the digital currency, the payer can input, through its software system, the public key pk_{A}^{TEE}, digital currency type and payer rescue address addr_{A} present by the prayer, and the earliest rescue time t expected by the payer to its trusted hardware system, and requests its trusted hardware system to generate a rescue object for (pk_{A}^{TEE},sk_{A}^{TEE}), so that when the payer's trusted hardware system crashes, is damaged or lost, the payer can use the rescue object to retrieve the existing digital currency deposited at addr to the payer's rescue address addr_{A} after the earliest rescue time t.

After receiving the above parameters, the trusted hardware system of the payer verifies whether pk_{A}^{TEE} is marked as “rescue object has been generated” in the confidential storage space; if so, it returns the “rescue object has been generated” to the software system of the payer; if not, according to the digital currency types, it is classified as digital currency (such as Bitcoin) that supports deferred transactions, digital currency (such as Ethereum) that does not support deferred transactions but supports smart contracts, and digital currency that neither supports deferred transactions nor smart contracts, and corresponding rescue objects can be generated.

For digital currency, including but not limited to Bitcoin, which supports deferred transactions, the trusted hardware system of the payer generates a transaction tx_{A} that uses sk_{A}^{TEE} for signature, the nTimeLock field being the above earliest rescue time t expected by the payer, the SIGHASH flag bit being SIGHASH_ALL, and transferring from addr to addr_{A}, and the transaction tx_{A} is returned to the software system of the payer as the rescue object. The advantages of this step are as follows: by generating tx_{A}, it is ensured that the prayer can retrieve the digital currency deposited at addr d to addr_{A} by using tx_{A} when it loses its trusted hardware system or its trusted hardware system crashes or is damaged; by setting the nTimeLock field to t, it is ensured that tx_{A} can only be executed after t; and by setting the SIGHASH position to SIGHASH_ALL, it is ensured that the earliest executable time of tx_{A} cannot be modified by any one by modifying the nTimeLock field in tx_{A}.

For digital currency, including but not limited to Ethereum, which does not support deferred transactions but supports smart contracts, the trusted hardware system of the payer generates a deferred transfer function to call the smart contracts that support deferred transactions, so as to realize a called transaction call_{A} of transferring from addr to addr_{A} with earliest executable time being t, and the transaction call_{A} is returned to the software system of the payer as a rescue object. Smart contracts supporting deferred transactions include but are not limited to smart contracts that use any method to realize deferred transfer, such as https://github.com/chatch/hashed-timelock-contract-ethereum or https://github.com/pawurb/Locker or https://github.com/GOOGZHOU/htlc-lc-eth or other implementation methods. The advantage of this step is that the payer can use call_{A} to retrieve the digital currency deposited at addr to addr_{A} when it loses its trusted hardware system or its trusted hardware system crashes or is damaged, and the earliest executable time parameter for calling the deferred transfer function in call_{A} is set to be t to ensure that call_{A} can be executed only after t.

For digital currency, which does not support deferred transactions or smart contracts, the trusted hardware system of the payer obtains the current time t_{now} through a trusted clock or trusted timing point, and generates a time lock puzzle puzzle_{A} with a secret being sk_{A}^{TEE}, a computing performance being a current computing performance constant and an unlocking duration being t−t_{now} through a generation algorithm in time lock puzzle algorithms (including but not limited to RSW time lock puzzle algorithms) and returns the time lock puzzle to the software system of the payer as the rescue object. The advantage of this step is that by generating puzzle_{A}, it is guaranteed that the payer can use the decryption algorithm of the corresponding time lock puzzle algorithm to solve sk_{A}^{TEE} when its trusted hardware system is lost or its trusted hardware system crashes or is damaged, so that the software system can be used to generate a transaction of transferring from addr to the personal digital currency address of the payer, and after the payer submits the transaction to the blockchain, retrieve the digital currency can be retrieved. In addition, by setting a unlocking duration to t−t_{now} in the process of generating puzzle_{A}, it is ensured that the payer can only solve sk_{A}^{TEE} from puzzle_{A} at a time before or after t within a certain error time, thus ensuring that the payer can only retrieve the digital currency deposited at addr at the time before or after t within a certain error time.

After the rescue object is generated, the trusted hardware system of the payer marks pk_{A}^{TEE} as “the rescue object has been generated” in the confidential storage space, uses [symbol] to sign the earliest rescue time t expected by the payer to generate a signature σₜ, and returns the rescue object, the rescue time t and the signature σₜ to the software system of the payer, so that the payer can derive the rescue object from its software system and save it to any location.

In an embodiment, after saving the rescue object, if the payer loses its trusted hardware system or its trusted hardware system crashes or is damaged, it can use the rescue object to retrieve the digital currency at addr. Depending on the type of digital currency, the payer needs to retrieve it back in different ways:

For a digital currency, including but not limited to Bitcoin, that supports deferred transactions, after submitting the earliest rescue time t expected by the payer, the payer submits tx_{A} to a blockchain system through the software system thereof or any blockchain client supporting the digital currency, and retrieves the digital currency deposited at addr to the rescue address addr_{A} after confirmation by the blockchain system.

For a digital currency, including but not limited to Ethereum, that does not support deferred transactions but supports smart contracts, after submitting the earliest rescue time t expected by the payer, the payer submits call_{A} to the blockchain system through the software system thereof or any blockchain client that supports the digital currency, and retrieves the digital currency deposited at addr to the rescue address addr_{A} after confirmation by the blockchain system.

For a digital currency that does not support deferred transactions or smart contracts, the payer immediately starts to execute a decryption algorithm of the corresponding time lock puzzle algorithm after obtaining puzzle_{A}, and the payer solves puzzle_{A} to obtain sk_{A}^{TEE} before and after the earliest rescue time t expected by the payer within a certain error time, generates a transaction of transferring from addr to the personal digital currency address of the payer with the software system, and submits the transaction to the blockchain to retrieve the digital currency.

It should be noted that because the core idea of the time-locked puzzle algorithm is to create a computing task, the time required for its solution is predictable. However, there are errors in this algorithm for two main reasons: first, the time required for different hardware to perform the same computing task may be different, and the high-performance processor may complete the task faster than the low-performance processor, resulting in the difference in computing time; secondly, with the development of technology, the performance of a new generation of processors is constantly improving, which shortens the time required for the originally designed computing tasks. These factors lead to a certain error range in the time prediction of the time lock puzzle algorithm in practical application. This error range may range from a few seconds to several minutes, depending on the performance difference of the hardware used and the speed of technological progress.
(3) The software system of the payer sends the digital currency address addr and the earliest rescue time t expected by the payer to the software system of the payee, and the software system of the payee (through the blockchain browser or any other method) browses the information of the digital currency address addr in step (2) saved in the blockchain, verifies whether there is a corresponding digital currency deposited at addr and confirms whether to accept the earliest rescue time t expected by the payer. If the payee does not accept the earliest rescue time t expect by the payer, the transaction is terminated; otherwise, after the verification is complete, the software system of the payee gives an encryption public key pk_{B} to the software system of the payer. The public key can be the public key [symbol] of the trusted hardware of the payee, or any public key.
(4) The software system of the payer sends pk_{A}^{TEE} and the public key pk_{B} provided by the payee to the trusted hardware system of the payer, requesting it to transfer (pk_{A}^{TEE}, sk_{A}^{TEE}), and the trusted hardware system of the payer uses pk_{B} to perform asymmetric encryption on sk_{A}^{TEE} to generate a ciphertext C_{A}, deletes (pk_{A}^{TEE},sk_{A}^{TEE}) in the confidential storage space, signs it with its trusted hardware signature private key [symbol] to sign for C_{A} to generate a signature σ′_{A}, and returns C_{A} and σ′_{A} to the software system of the payer.

The payer inputs the public key provided by the payee to the software system of the payer, and the software system of the payer transmits the public key and the transfer request to the trusted hardware of the payer. The trusted hardware of the payer uses this public key to asymmetrically encrypt the public-private key pair in step 1 to generate ciphertext, deletes the public-private key pair in the trusted storage space, signs the ciphertext with the private key of the trusted hardware, and returns the ciphertext and signature to the software system of the payer.
(5) The software system of the payer sends the public key pk_{A}^{TEE}, the signature σ_{A}, the ciphertext C_{A}, the signature σ′_{A}, the earliest rescue time t expected by the payer and the signature σₜ to the software system of the payee.
(6) If the public key pk_{B} is a trusted hardware encryption public key [symbol] of the trusted hardware of the payee, the software system of the payee sends the public key pk_{A}^{TEE}, the signature σ_{A}, the ciphertext C_{A}, the signature σ′_{A}, the rescue time t, the signature σₜ and a trusted hardware signature public key [symbol] of the payer to the trusted hardware of the payee, and the trusted hardware system of the payee uses [symbol] to verify whether σ_{A} is a signature for pk_{A}^{TEE} by the payer using [symbol] , whether σ′_{A} is a signature for C_{A} by the payer using [symbol] and whether σₜ is a signature for t by the payer using [symbol] ; if the verify is passed, it is determined whether the rescue time t is in an acceptable range, and if acceptable, asymmetrically decryption is performed on C_{A} by using [symbol] to obtain sk_{A}^{TEE}, and (pk_{A}^{TEE},sk_{A}^{TEE}) is saved.

After this step, the payee can input, through its software system, the public key pk_{B}^{TEE}, digital currency type and the payee rescue address addr_{B} preset by the payee and the earliest rescue time t′ expected by the payee to its trusted hardware system, and request its trusted hardware system to generate a rescue object for (pk_{A}^{TEE},sk_{A}^{TEE}), so that when the trusted hardware system of the payee crashes, is damaged or lost, the payee can use the rescue object to retrieve the digital currency deposited at addr to the rescue address addr_{B} after the earliest rescue time t′. The earliest rescue time t′ expected by the payee must be at least a constant Δ of seconds earlier than the earliest rescue time t expected by the payer, so as to ensure that when the payee loses its trusted hardware system or its trusted hardware system crashes or is damaged, it can still retrieve the digital currency deposited at addr earlier than the payer.

After receiving the above parameters, the trusted hardware system of the payee verifies whether pk_{A}^{TEE} is marked as “rescue object has been generated” in the confidential storage space; if so, it returns the “rescue object has been generated” to the software system of the payee; if not, according to the digital currency types, it is classified as digital currency (such as Bitcoin) that supports deferred transactions, digital currency (such as Ethereum) that does not support deferred transactions but supports smart contracts, or digital currency that neither supports deferred transactions nor smart contracts, and corresponding rescue objects can be generated.

For digital currency, including but not limited to Bitcoin, which supports deferred transactions, the trusted hardware system of the payee generates a transaction tx_{B} that uses sk_{A}^{TEE} for signature, the nTimeLock field being the rescue time t′, the SIGHASH flag bit being SIGHASH_ALL, and transferring from addr to addr_{B}, and the transaction is returned to the software system of the payee as the rescue object. The advantages of this step are as follows: by generating tx_{B}, it is ensured that the payee can retrieve the digital currency deposited at addr d to addr_{B} by using tx_{B} when it loses its trusted hardware system or its trusted hardware system crashes or is damaged; by setting the nTimeLock field to t′, it is ensured that tx_{B} can only be executed after t′; and by setting the SIGHASH position to SIGHASH_ALL, it is ensured that the earliest executable time of tx_{B} cannot be modified by any one by modifying the nTimeLock field in tx_{B}.

For digital currency, including but not limited to Ethereum, which does not support deferred transactions but supports smart contracts, the trusted hardware system of the payee generates a deferred transfer function to call the smart contracts that support deferred transactions, so as to realize a called transaction call_{B} of transferring from addr to addr_{B} with the earliest executable time being t′, and the transaction is returned to the software system of the payee as a rescue object. Smart contracts supporting deferred transactions include but are not limited to smart contracts that use any method to realize deferred transfer. The advantage of this step is that the payee can use call_{B} to retrieve the digital currency deposited at addr to addr_{B} when it loses its trusted hardware system or its trusted hardware system crashes or is damaged, and the earliest executable time parameter for calling the deferred transfer function in call_{B} is set to be t′ to ensure that call_{B} can be executed only after t′.

For digital currency, which does not support deferred transactions or smart contracts, the trusted hardware system of the payee obtains the current time t_{now′} through a trusted clock or trusted timing point, and generates a time lock puzzle puzzle_{B} with a secret being sk_{A}^{TEE}, a computing performance being a current computing performance constant and an unlocking duration being t′−t_{now′} through a generation algorithm in time lock puzzle algorithms (including but not limited to RSW time lock puzzle algorithms) and returns the time lock puzzle to the software system of the payee as the rescue object. The advantage of this step is that by generating puzzle_{B}, it is guaranteed that the payee can use the decryption algorithm of the corresponding time lock puzzle algorithm to solve sk_{A}^{TEE} when its trusted hardware system is lost or its trusted hardware system crashes or is damaged, so that the software system can be used to generate a transaction of transferring from addr to the personal digital currency address of the payee, and after the payee submits the transaction to the blockchain, retrieve the digital currency can be retrieved. In addition, by setting a unlocking duration to t′−t_{now} in the process of generating puzzle_{B}, it is ensured that the payee can only solve sk_{A}^{TEE} from puzzle_{B} at a time before or after t′ within a certain error time, thus ensuring that the payee can only retrieve the digital currency deposited at addr at the time before or after t′ within a certain error time.

After the rescue object is generated, the trusted hardware system of the payee marks pk_{A}^{TEE} as “the rescue object has been generated” in the confidential storage space, uses [symbol] to sign the earliest rescue time t′ expected by the payee to generate a signature σ_{t′}, and returns the rescue object, the rescue time t′ and the signature σ_{t′} to the software system of the payee, so as to be used for transactions when the payee is a payer in other transactions at this time, and the payee can export the above-mentioned rescue object from its software system and save it to any location.

In an embodiment, after saving the rescue object, if the payee loses its trusted hardware system or its trusted hardware system crashes or is damaged, it can use the rescue object to retrieve the digital currency at addr. Depending on the type of digital currency, the payee needs to retrieve it back in different ways:

For a digital currency, including but not limited to Bitcoin, that supports deferred transactions, after submitting the earliest rescue time t′ expected by the payee, the payee submits tx_{B} to a blockchain system through the software system thereof or any blockchain client supporting the digital currency, and retrieves the digital currency deposited at addr to the rescue address addr_{B} after confirmation by the blockchain system.

For a digital currency, including but not limited to Ethereum, that does not support deferred transactions but supports smart contracts, after submitting the earliest rescue time t′ expected by the payee, the payee submits call_{B} to the blockchain system through the software system thereof or any blockchain client that supports the digital currency, and retrieves the digital currency deposited at addr to the rescue address addr_{B} after confirmation by the blockchain system.

For a digital currency that does not support deferred transactions or smart contracts, the payee immediately starts to execute a decryption algorithm of the corresponding time lock puzzle algorithm after obtaining puzzle_{B}, and the payee solves puzzle_{B} to obtain sk_{A}^{TEE} around the earliest rescue time t′, generates a transaction of transferring from addr to the personal digital currency address of the payee with the software system, and submits the transaction to the blockchain to retrieve the digital currency.
(7) Otherwise, the software system of the payee uses [symbol] to verify whether σ_{A} is a signature for pk_{A}^{TEE} by the payer using [symbol] and whether σ′_{A} is a signature for C_{A} by the payer using [symbol] ; if the verify is passed, C_{A} is decrypted with a corresponding private key sk_{B} of the public key pk_{B}, the software system of the payee uses (pk_{A}^{TEE},sk_{A}^{TEE}) to generate a transaction of transferring from the corresponding digital currency address addr to a personal digital currency address of the payee and submitting the transaction to the blockchain for withdrawal for the digital currency.

Thereafter, the payee can use (pk_{A}^{TEE},sk_{A}^{TEE}) to generate a transaction of transferring from the corresponding digital currency address addr to the personal digital currency address of the payee through its software system, and submit it to the blockchain for withdrawal for digital currency.

After the execution of the above steps, the payment part of the method for digital currency intra-chain and cross-chain off-chain rescuable payments based on trusted hardware is completed.

As shown in FIG. 3, if the payee needs to withdraw digital currency after performing step 6, the following be executed.
(8) The software system of the payee sends a public key pk′_{B} to the trusted hardware system of the payee, requesting the transfer of (pk_{A}^{TEE},sk_{A}^{TEE}), and the trusted hardware of the payee uses pk′_{B} to perform asymmetric encryption on sk_{A}^{TEE} to generate a ciphertext C′_{A}, deletes (pk_{A}^{TEE},sk_{A}^{TEE}) from the confidential storage space, uses a trusted hardware signature private key [symbol] thereof to sign C′_{A} to generate a signature σ″_{A}, and returns C′_{A} and σ″_{A} to the software system of the payee.
(9) The software system of the payee first uses [symbol] to verify whether σ′_{A} is a signature for pk_{A}^{TEE} by the payee using [symbol] , and then uses [symbol] to verify whether σ″_{A} is a signature for C′_{A} by the trusted hardware system of the payee using [symbol] ; if the verification is passed, the corresponding private key sk′_{B} of the public key pk′_{B} is used to decrypt the ciphertext C′_{A} to obtain sk_{A}^{TEE}, and the payee uses (pk_{A}^{TEE},sk_{A}^{TEE}) to generate a transaction of transferring from addr to the personal digital currency address of the payee through the software system thereof, and submits the transaction to the blockchain for withdrawal for the digital currency.

In this embodiment, the specific implementation of the above steps is the same as that of Example 1, unless otherwise specified, and will not be repeated here.

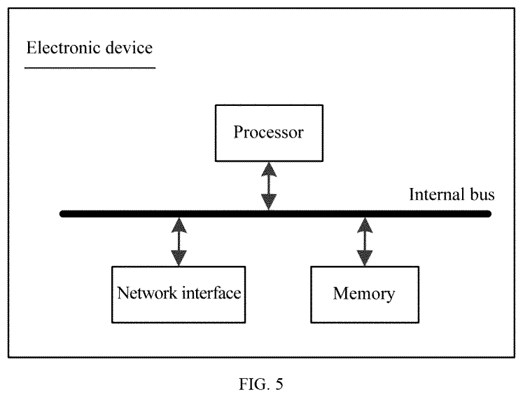

Correspondingly, the present disclosure further provides an electronic device, which includes one or more processors; a memory for storing one or more programs; when the one or more programs are executed by the one or more processors, the one or more processors are enabled to implement the above-mentioned method for digital currency intra-chain and cross-chain off-chain payments based on trusted hardware or method for digital currency intra-chain and cross-chain off-chain rescuable payments based on trusted hardware. As shown in FIG. 5, it is a hardware structure diagram of any equipment with data processing capability where a method for digital currency in-chain and cross-chain off-chain payment based on trusted hardware or a method for digital currency in-chain and cross-chain off-chain rescuable payment based on trusted hardware provided by the embodiment of the present disclosure is located. In addition to the processor, memory and network interface shown in FIG. 5, any equipment with data processing capability where the device in the embodiment is located can usually include other hardware according to the actual function of the equipment with data processing capability, which will not be described here again.

Correspondingly, the present disclosure further provides a computer-readable storage medium, on which computer instructions are stored, which, when executed by a processor, implement the above-mentioned method for digital currency intra-chain and cross-chain off-chain payments based on trusted hardware or the method for digital currency intra-chain and cross-chain off-chain rescuable payments based on trusted hardware. The computer-readable storage medium can be an internal storage unit of any equipment with data processing capability as described in any of the previous embodiments, such as a hard disk or a memory. The computer-readable storage medium can further be an external storage device, such as a plug-in hard disk, Smart Media Card (SMC), SD card, Flash Card, etc. provided on the device. Further, the computer-readable storage medium can further include both internal storage units and external storage devices of any equipment with data processing capability. The computer-readable storage medium is used for storing the computer program and other programs and data required by any equipment with data processing capability, and can further be used for temporarily storing data that has been output or will be output.

Other embodiments of the present disclosure will easily be conceived by those skilled in the art after considering the specification and practicing the disclosure herein. The present disclosure is intended to cover any variations, uses or adaptations of the present disclosure, which follow the general principles of the present disclosure and include common sense or common technical means in this technical field that are not disclosed in the present disclosure.

It should be appreciated that the present disclosure is not limited to the precise structure described above and shown in the drawings, and various modifications and changes can be made without departing from its scope.

What is claimed is:

1. A method for digital currency intra-chain and cross-chain off-chain payments based on trusted hardware, comprising:
step (1) randomly generating, by a trusted hardware system of a payer, a public-private key pair (pk_{A}^{TEE},sk_{A}^{TEE}), generating, by a private key sk_{A}^{TEE}, a signature σ_{A} for a public key pk_{A}^{TEE}, and returning the public key pk_{A}^{TEE} and the signature σ_{A} to a software system of the payer;
step (2) calculating, by the software system of the payer, a digital currency address addr through the public key pk_{A}^{TEE}, and depositing, by a blockchain, a digital currency to the digital currency address addr;
step (3) sending, by the software system of the payer, the digital currency address addr to a software system of a payee, and verifying, by the software system of the payee, whether there is a corresponding digital currency at addr; and after verifying, transmitting, by the software system of the payee, an encryption public key pk_{B} to the software system of the payer;
step (4) sending, by the software system of the payer, the public keys pk_{A}^{TEE} and the encryption public key pk_{B} to the trusted hardware system of the payer, requesting the trusted hardware system of the payer to transfer (pk_{A}^{TEE},sk_{A}^{TEE}), performing, by the trusted hardware system of the payer, asymmetric encryption on sk_{A}^{TEE} by using pk_{B} to generate a ciphertext C_{A}, deleting (pk_{A}^{TEE},sk_{A}^{TEE}) from a confidential storage space of the trusted hardware system of the payer, signing the ciphertext C_{A} by a trusted hardware signature private key [symbol] to generate a signature σ′_{A}, and returning the ciphertext C_{A} and the signature σ′_{A} to the software system of the payer;
step (5) sending, by the software system of the payer, the public key pk_{A}^{TEE}, the signature σ_{A}, the ciphertext C_{A} and the signature σ′_{A} to the software system of the payee;
step (6) when the public key pk_{B} being a trusted hardware encryption public key [symbol] of the trusted hardware of the payee, sending, by the software system of the payee, the public key pk_{A}^{TEE}, the signature σ_{A}, the ciphertext C_{A}, the signature σ′_{A} and a trusted hardware signature public key [symbol] of the payer to the trusted hardware of the payee, verifying, by the trusted hardware system of the payee, whether σ_{A} is a signature for pk_{A}^{TEE} by the payer using [symbol] and whether σ′_{A} is a signature for the ciphertext C_{A} by the payer using [symbol] by using the trusted hardware signature public key [symbol] , when said verifying being passed, decrypting, by [symbol] , the ciphertext C_{A} to obtain sk_{A}^{TEE}, and saving (pk_{A}^{TEE},sk_{A}^{TEE}); and
step (7) when the public key pk_{B} not being a trusted hardware encryption public key [symbol] of the trusted hardware of the payee, verifying, by the software system of the payee, whether σ_{A} is a signature for pk_{A}^{TEE} by the payer using [symbol] and whether σ′_{A} is a signature for the ciphertext C_{A} by the payer using [symbol] by using [symbol] , when said verifying being passed, decrypting, by a corresponding private key sk_{B} of the public key pk_{B}, the ciphertext C_{A} to obtain sk_{A}^{TEE}, generating, by the software system of the payee, a transaction that is transferred from the corresponding digital currency address addr to a personal digital currency address of the payee by using (pk_{A}^{TEE},sk_{A}^{TEE}), and submitting the transaction to the blockchain for withdrawal for the digital currency, so as to avoid on-chain swap and improve timeliness of digital currency intra-chain and cross-chain transaction payment flow.

2. The method according to claim 1, wherein said storing, by the trusted hardware system of the payer or the payee, the public-private key pair (pk_{A}^{TEE},sk_{A}^{TEE}) in the confidential storage space comprises: directly storing the public-private key pair in the trusted hardware or encrypting the public-private key pair by the trusted hardware with a key that does not leak and storing the public-private key pair in a specific area, wherein data stored in the confidential storage space are not capable of being read by any device, system, software or user except the trusted hardware system in any way.

3. The method according to claim 1, further comprising: before verifying by the payee in the step (3), when there has been no prior transaction between the payee and the payer, calling, by the software system of the payee, trusted hardware attestation technology to verify whether the trusted hardware system of the payer is running on a reliable trusted hardware, and when verifying being passed, obtaining the public key of the trusted hardware signature [symbol] of the payer and storing the public key of the trusted hardware signature [symbol] of the payer in the software system of the payee.

4. The method according to claim 1, wherein after the step (6), when the payee needs to withdraw a digital currency, following steps are performed:
inputting, by the software system of the payee, a public key pk′_{B} to the trusted hardware system of the payee, requesting the trusted hardware system of the payee to transfer (pk_{A}^{TEE},sk_{A}^{TEE}), performing, by the trusted hardware system of the payee, asymmetric encryption on sk_{A}^{TEE} by using pk′_{B}, to generate a ciphertext C′_{A}, deleting (pk_{A}^{TEE}sk_{A}^{TEE}) from the confidential storage space, signing the ciphertext C′_{A} by a trusted hardware signature private key [symbol] generate a signature σ″_{A}, and sending the ciphertext C′_{A} and the signature σ″_{A} to the software system of the payee; and
verifying, by the software system of the payee, whether σ′_{A} is a signature for pk_{A}^{TEE} by the payee using [symbol] and whether σ″_{A} is a signature for the ciphertext C′_{A} by the trusted hardware system of the payee using [symbol] by using the [symbol] , when said verifying being passed, decrypting, by a corresponding private key sk′_{B} of the public key pk′_{B}, the ciphertext C′_{A} to obtain sk_{A}^{TEE}, generating, by the software system of the payee, a transaction of transferring from addr to the personal digital currency address of the payee by using (pk_{A}^{TEE},sk_{A}^{TEE}), and submitting the transaction to the blockchain for withdrawal for the digital currency.

5. A method for digital currency intra-chain and cross-chain off-chain rescuable payments based on trusted hardware, comprising:
step (1) randomly generating, by a trusted hardware system of a payer, a public-private key pair (pk_{A}^{TEE},sk_{A}^{TEE}), generating, by a private key sk_{A}^{TEE}, a signature σ_{A} for a public key pk_{A}^{TEE}, and returning the public key pk_{A}^{TEE} and the signature σ_{A} to a software system of the payer;
step (2) calculating, by the software system of the payer, a digital currency address addr through the public key pk_{A}^{TEE}, depositing, by a blockchain, a digital currency to the digital currency address; sending, by the software system of the payer, the public key pk_{A}^{TEE}, a digital currency type, a payer rescue address addr_{A} preset by the payer, and an earliest rescue time t expected by the payer to the trusted hardware system of the payer, requesting the trusted hardware system of the payer to generate a rescue object for (pk_{A}^{TEE},sk_{A}^{TEE}), signing the earliest rescue time t expected by the payer using [symbol] to generate a signature σₜ, and sending the rescue object, the earliest rescue time t expected by the payer, and the signature σₜ to the software system of the payer;
step (3) sending, by the software system of the payer, the digital currency address addr and the earliest rescue time t expected by the payer to a software system of a payee, and verifying, by the software system of the payee, whether there is a corresponding digital currency at addr and confirming whether to accept the earliest rescue time t expected by the payer; and when the payee does not accept the earliest rescue time t expected by the payer, terminating the transaction, otherwise, after verifying, transmitting, by the software system of the payee, an encryption public key pk_{B} to the software system of the payer;
step (4) sending, by the software system of the payer, the public keys pk_{A}^{TEE} and the encryption public key pk_{B} to the trusted hardware system of the payer, requesting the trusted hardware system of the payer to transfer (pk_{A}^{TEE},sk_{A}^{TEE}), performing, by the trusted hardware system of the payer, asymmetric encryption on sk_{A}^{TEE} by using pk_{B} to generate a ciphertext C_{A}, deleting (pk_{A}^{TEE},sk_{A}^{TEE}) from a confidential storage space of the trusted hardware system of the payer, signing the ciphertext C_{A} by a trusted hardware signature private key [symbol] to generate a signature σ′_{A}, and returning the ciphertext C_{A} and the signature σ′_{A} to the software system of the payer;
step (5) sending, by the software system of the payer, the public key pk_{A}^{TEE}, the signature σ_{A}, the ciphertext C_{A}, the signature σ′_{A}, the earliest rescue time t expected by the payer and the signature σₜ to the software system of the payee;
step (6) when the public key pk_{B} being a trusted hardware encryption public key [symbol] of the trusted hardware of the payee, sending, by the software system of the payee, the public key pk_{A}^{TEE}, the signature σ_{A}, the ciphertext C_{A}, the signature σ′_{A}, the rescue time t, the signature σₜ and a trusted hardware signature public key [symbol] of the payer to the trusted hardware of the payee, verifying, by the trusted hardware system of the payee, whether σ_{A} is a signature for pk_{A}^{TEE} by the payer using [symbol] , whether σ′_{A} is a signature for C_{A} by the payer using [symbol] and whether σₜ is a signature for t by the payer using [symbol] by using [symbol] , when said verifying being passed, determining whether the rescue time t is in an acceptable range, and when the rescue time t is in the acceptable range, performing asymmetrically decryption on C_{A} by using [symbol] to obtain sk_{A}^{TEE} and storing (pk_{A}^{TEE},sk_{A}^{TEE}); and sending, by the software system of the payee, the public key pk_{B}^{TEE}, a digital currency type, a payee rescue address addr_{B} preset by the payee and an earliest rescue time t′ expected by the payee to the trusted hardware system of the payee, and requesting the trusted hardware system of the payee to generate a rescue object for (pk_{A}^{TEE},sk_{A}^{TEE}); and
step (7) when the public key pk_{B} not being a trusted hardware encryption public key [symbol] of the trusted hardware of the payee, verifying, by the software system of the payee, whether σ_{A} is a signature for pk_{A}^{TEE} by the payer using [symbol] and whether σ′_{A} is a signature for the ciphertext C_{A} by the payer using [symbol] by using [symbol] , when said verifying being passed, decrypting, by a corresponding private key sk_{B} of the public key pk_{B}, the ciphertext C_{A} to obtain sk_{A}^{TEE}, generating, by the software system of the payee, a transaction that is transferred from the corresponding digital currency address addr to a personal digital currency address of the payee by using (pk_{A}^{TEE},sk_{A}^{TEE}), and submitting the transaction to the blockchain for withdrawal for the digital currency, so as to avoid asset loss when the trusted hardware is damaged or lost.

6. The method according to claim 5, further comprising:
for a digital currency that supports deferred transactions, generating, by the trusted hardware system of the payer, a transaction tx_{A} signed with sk_{A}^{TEE}, with a nTimeLock field being the earliest rescue time t expected by the payer and a SIGHASH flag bit being SIGHASH_ALL, and transferred from addr to addr_{A}, and returning the transaction tx_{A} as the rescue object to the software system of the payer;
for a digital currency that does not support deferred transactions but supports smart contracts, generating, by the trusted hardware system of the payer, a deferred transfer function that calls smart contracts that support deferred transactions, so as to achieve a called transactions call_{A} of transferring from addr to addr_{A} with an earliest executable time being t, and returning the transaction call_{A} as the rescue object to the software system of the payer; and
for a digital currency that does not support deferred transactions or smart contracts, obtaining, by the trusted hardware system of the payer, a current time t_{now} through a trusted clock or trusted timing point, generating a time lock puzzle puzzle_{A} with a secret being sk_{A}^{TEE}, a computing performance being a current computing performance constant and an unlocking duration being t−t_{now} through a generation algorithm in a time lock puzzle algorithm, and returning the time lock puzzle puzzle_{A} to the software system of the payer as the rescue object, wherein the time lock puzzle algorithm comprises but is not limited to RSW time lock puzzle algorithms.

7. The method according to claim 6, wherein a process for the payer to retrieve the digital currency deposited at addr to the rescue address addr_{A} comprises:
for the digital currency that supports the deferred transactions, after submitting the earliest rescue time t expected by the payer, submitting, by the payer, tx_{A} to a blockchain system through the software system of the payer or any blockchain client supporting the digital currency, and retrieving the digital currency deposited at addr to the rescue address addr_{A} after confirmation by the blockchain system;
for the digital currency that does not support the deferred transactions but supports the smart contracts, after submitting the earliest rescue time t expected by the payer, submitting, by the payer, call_{A} to the blockchain system through the software system of the payer or any blockchain client that supports the digital currency, and retrieving the digital currency deposited at addr to the rescue address addr_{A} after confirmation by the blockchain system; and
for the digital currency that does not support the deferred transactions or the smart contracts, immediately starting, by the payer, to execute a decryption algorithm of the corresponding time lock puzzle algorithm after obtaining the time lock puzzle puzzle_{A}, solving, by the payer, the time lock puzzle puzzle_{A} to obtain sk_{A}^{TEE} before and after the earliest rescue time t expected by the payer, generating a transaction of transferring from addr to the personal digital currency address of the payer with the software system, and submitting the transaction to the blockchain to retrieve the digital currency.

8. The method according to claim 5, wherein after the step (6), when the payee needs to withdraw a digital currency, following steps are performed:
sending, by the software system of the payee, a public key pk′_{B} to the trusted hardware system of the payee, requesting the trusted hardware system of the payee to transfer (pk_{A}^{TEE},sk_{A}^{TEE}), performing, by the trusted hardware of the payee asymmetric encryption on sk_{A}^{TEE} by using pk′_{B}, to generate a ciphertext C′_{A}, deleting (pk_{A}^{TEE},sk_{A}^{TEE}) from the confidential storage space, signing the ciphertext C′_{A} by a trusted hardware signature private key [symbol] , to generate a signature σ″_{A}, and returning the ciphertext C′_{A} and the signature σ″_{A} to the software system of the payee; and
verifying, by the software system of the payee, whether σ′_{A} is a signature for pk_{A}^{TEE} by the payee using [symbol] , using [symbol] to verify whether σ″_{A} is a signature for C′_{A} by the trusted hardware system of the payee using [symbol] by using [symbol] , when said verifying being passed, decrypting, by the corresponding private key sk′_{B} of the public key pk′_{B}, the ciphertext C′_{A} to obtain sk_{A}^{TEE}, generating, by the payee, a transaction of transferring from addr to the personal digital currency address of the payee by using (pk_{A}^{TEE},sk_{A}^{TEE}) through the software system of the payee, and submitting the transaction to the blockchain for withdrawal for the digital currency.

9. An electronic device, comprising:
one or more processors; and
a memory for storing one or more programs;
wherein the one or more programs, when executed by the one or more processors, cause the one or more processors to implement the method according to claim 1.

10. A non-transitory computer-readable storage medium on which computer instructions are stored, wherein the instructions, when executed by a processor, is configured to implement the method according to claim 1.
